(19) United States
(12) Patent Application Publication
(10) Pub. No.: US 2003/0018484 A1
(43) Pub. Date: Jan. 23, 2003

(54) Cost manager user interface in transaction processing system

(76) Inventors: Robert B. Franks, Sheffield (GB); Martin M. Neilson, Sheffield (GB)

Correspondence Address: HARNESS, DICKEY & PIERCE, P.L.C., P.O. BOX 828, BLOOMFIELD HILLS, MI, 48303, US

(21) Appl. No.: 09/909,397

(22) Filed: Jul. 19, 2001

(51) Int. Cl. G06F 17/60

(52) U.S. Cl. 705/1

(57) ABSTRACT

There is disclosed a user interface and underlying trading engine for an online trade mark registration process. The user interface comprises a cost calculator window, which lists total cost of filing a registered trade mark application, which is calculated in real time. A user may select/deselect various items such as classes of goods/services, priority claims, seniority claims, territories in which to file a trade mark application, where upon the real time cost is amended in real time to reflect the cost of the amended filing program having selected/deselected parameters. Costs can be displayed in a plurality of different currencies, to allow a user to compare filing costs from one service provider to another, in a same currency, and to improve the usability of the service.

### FIELD OF THE INVENTION

The present invention relates to the field of electronic commerce systems and, particularly, although not exclusively, to an electronic commerce system capable of handling transactions concerning the filing and registration of trade mark applications.

### BACKGROUND TO THE INVENTION

Historically, trade mark rights have been allocated according to national laws by a process of registering trade mark applications at governmental or intergovernmental bodies. Historically, transactions have been via a paper-based application process involving the filling in of paper application forms which are then sent by surface mail or by facsimile to a governmental office by a trade mark agent or attorney.

On the other hand, the registration of domain names is made predominantly on-line over the internet by filling in electronic forms on a website. Domain name registration typically involves filling in a domain name on a website form; entering name and address; entering payment details and confirming an order to register the domain name. There are no further registration formalities required and domain names are allocated on a first come-first served basis.

Recently, websites have appeared on the internet through which simple registered trade mark applications can be applied for. Websites for registering US and Canadian trade marks include www.trademarksonline.com and www.tmweb.com. Other web sites offering filing of trade marks in the US include: Trade Mark Express® (www.tmexpress.com); Trade mark USA (www.trademark-USA.com); 4Trademark.com; 1-2-3 Trademark (www.1-2-3trademark.com, www.trademarkinfo.com); Name Protect (www.nameprotect.com); Tradename.com (www.tradename.com); and Available Trade mark Domain (www.trademarkdomaininusa.com). All of these sites offer either no registration service for trade marks, or single country trade mark registration at a fixed price many of these site offer searching only. Trademark USA® allows for filling in an online form for filing a trade mark application at a fixed price with add-on costs for a logo, or state trade mark in single US state. 1-2-3 Trademark offers a displayed price list for a single country trade mark leaving a customer to calculate the cost of preparing and filing an application themselves. Name Protect.com offers fixed price US Federal trade mark registration, including both standard or intent to use applications, which provides a customised application form which is downloaded onto a customers computer which is then printed out and signed by the customer who has to physically post this to the United States Patent Office along with a cheque for the government application fee. 1-2-3 Trademark simply allows ordering of a trade mark filing by a one click system, which results in a trade mark attorney contacting by telephone, a customer. Tradename.com allows fixed price searching and domain name registration in a plurality of countries, but does not allow for trade mark filing in any countries. Available trade mark domain allows for a one click trade mark registration ordering, which results in either trade mark attorneys preparing the application off-line, hiring an attorney (a normal client-attorney relationship not automated and not using electronic means), or a customer filling in the form themselves and sending it to the US Trade Mark Office. Trademarks On-line^{SM} allows on-line submission of a registered trade mark application by filling in an online form, but this is for a single country. Pricing is by means of a fixed price list comprising a vendor fee and the government filing fee for US trade marks only.

Whilst registration of a domain name is a relatively simple process, comparatively, registration of a trade mark is a complex process. Difficulties with trade mark registration include: definition of the trade mark itself, whether the mark is a logo, word, shape or other identifier; identification of goods and services for which the trade mark is to be registered; whether the registered trade mark application claims any earlier legal rights, for example to priority or seniority; requirements for legalization, notarization or apostiles in various territories; the fact that registered trade marks are searched and examined by national governments or intergovernmental bodies; and the fact that applications to register trade marks can be opposed by third parties having an interest in a similar or identical mark. Conventional websites currently offer, in general, filing of a registered trade mark application in a single country, or a very limited number of countries, for example 2 or 3.

Historically, the cost of filing and registering a trade mark has been a large variable and difficult to quantify. Trade mark lawyers generally operate on a pay-per-hour basis, and the amount of time and professional effort required to register a trade mark can very drastically from mark to mark, even for two very similar marks within the same country.

The problem of variable cost per trade mark application inhibits the extension of on-line registered trade mark filing facilities in offering a wide range of different countries and inhibits applicants from using websites to apply to register trade mark applications. This is exemplified by the absence of web sites offering multi-country trade mark filing. Conventional trade mark filing websites generally offer a price list, which lists various optional items such as a search, a priority claim, and an extra classification, and a customer is left to add up the cost of a trade mark application themselves before committing to a transaction. Alternatively, some websites offer a fixed price, and a vendor running the website is left to make sure that the fixed price, on average, is enough to remain profitable.

### SUMMARY OF THE INVENTION

The inventors have identified problems with conventional trade mark filing websites in particular in the provision of cost information for filing and prosecution of a registered trade mark application.

One object of the present invention is to provide an on-line transaction system in which a customer can instruct the filing of a registered trade mark application for a particular mark in one or a plurality of countries at once, via an on-line system without the need to re-enter data defining the application, whilst being able to monitor, in real time, and at the time of instruction, the cost of filing one or a plurality of trade mark applications.

Specific implementations of the present invention aim to allow a customer to add or delete from a trade mark application filing program different territories, different classes of goods and services, and select whether priority and seniority claims will be made or not, whilst at the same time being able to monitor the consequences of adding/subtracting countries, classes of goods/services, and/or priority/seniority claims, and to tailor the trade mark application program to the customer's budget.

Preferably, a trade mark application filing program in a plurality of countries can be made by filling in a single electronic form, and amending the form interactively, in order to modify and tailor the trade mark application filing program to the customer's needs and resources.

In a specific implementation in use, a customer fills in details of a trade mark, individual goods and services in different classes, and priority claims to be made from an earlier filing of the same mark, and any seniority claims to be made from earlier marks in a single on-line electronic form filling operation. The customer may then deploy a filing program of the mark, by specifying different territories, and specifying different classes for different territories, the absence or existence of priority claims for different countries and similarly for seniority claims, whilst receiving real time cost data for a tailored filing program of the mark.

Further, the customer may obtain a comparison of prices in main currencies, for example US dollar, Euro or Yen, for the same filing program ,and may select a currency in which to transact the filing program to suit the customer's own accounting system.

According to a first aspect of the present invention there is provided a method of determining a cost data relating to a cost of a registered trade mark application, said method characterized by comprising the steps of: receiving input data describing a trade mark; receiving input data describing at least one territory; receiving input data describing a number of classes of goods/services for a said registered trade mark application; storing component cost data relating to a plurality of component costs of said registered trade mark application in at least one territory; and calculating substantially in real time said cost data relating to a cost of said registered trade mark application from said stored data.

According to a second aspect of the present invention there is provided a method of determining a cost of a registered trade mark application via an online interactive trading system, said method comprising the steps of inputting a trade mark; inputting a specification of goods/services relating to said trade mark; inputting at least one territory for said trade mark, said method characterized by; displaying a substantially real time calculated cost of applying for said trade mark in said at least one territory, for said specification of goods/services.

According to a third aspect of the present invention there is provided a method of activating a registered trade mark application via an online interactive trade system, said method comprising the steps of receiving an input trade mark data describing a trade mark; receiving an input specification of goods/services relating to the trade mark; receiving an input selection of at least one territory for said trade mark; characterized by displaying a substantially real time calculated cost of said trade mark in said at least one territory for said specification of goods/services.

According to a fourth aspect of the present invention there is provided a user interface display configured for displaying for a trade mark a plurality of classes of goods/services relating to said trade mark; at least one territory relating to said trade mark; and a substantially real time calculated cost relating to said trade mark.

According to a fifth aspect of the present invention there is provided a method of online trading, for instructing a registered trade mark application, said method comprising generating a display window for a trade mark, said display window displaying a list of individual territories relating to said trade mark; for each said territory, a list of classes of goods/services of said trade mark in said territory; for each said territory, a cost of said trade mark; wherein said cost is calculated substantially in real time.

According to a sixth aspect of the present invention there is provided a user interface for an online trading system, for filing a registered trade mark application, said user interface comprising a cost calculator window, displaying at least one trade mark in at least one country, and a calculated cost relating to said trade mark; a currency conversion window activated as an expansion of said cost calculator window, said currency conversion window capable of converting a cost from a first currency to a second currency, said cost selected from a total filing cost of a trade mark application in an individual territory; a total cost of a filing program of a trade mark in a plurality of territories; an official fee; a vendor fee charged by a vendor for providing a trade mark service; an associate fee charged by an associate for performing a trade mark service.

According to a seventh aspect of the present invention there is provided a means for generating a user interface display for displaying data relating to a trade mark, said data comprising data describing said trade mark; data describing at least one territory relating to said trade mark; data describing at least one class of goods/services relating to said trade mark; data relating to a cost of said trade mark; said means comprising means for storing of component cost data for a trade mark in each of a plurality of territories; means for calculating substantially in real time, a cost of said trade mark in at least one said territory.

Other aspects and features of the invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically an overview of a transaction system for serving a plurality of customers for the purpose of filing registered trade mark applications;

FIG. 2 illustrates schematically individual machine components comprising the system of FIG. 1 herein;

FIG. 3 illustrates schematically an architecture of a web server comprising a transaction processing engine for creating a user display and user interface for filing registered trade mark application;

FIG. 4 illustrates schematically an overview of operation of the host web server of FIG. 3;

FIG. 5 illustrates schematically a screen display presented as customer terminal generated by a host web server;

FIG. 6 illustrates schematically the first section of an order form presented a user interface display;

FIG. 7 illustrates schematically a second order form section displayed at the user interface;

FIG. 8 illustrates schematically a third order form section for ordering goods/services;

FIG. 9 illustrates schematically a fourth order form section for entering at least one priority claim;

FIG. 10 illustrates schematically a fifth order form section for entering at least one seniority claim;

FIG. 11 illustrates schematically a sixth order form section for entering applicant details;

FIG. 12 illustrates schematically a seventh order form section for confirmation of a trade mark order;

FIG. 13 illustrates schematically an architecture of a host web server and a customer terminal for generating a user interface and for receiving data for filing a registered trade mark application;

FIG. 14 illustrates schematically data types contained in a look up table of the web server;

FIG. 15 illustrates schematically further data types contained in a look up table of the web server;

FIG. 16 illustrates schematically cost data stored in a look up table of the web server;

FIG. 17 illustrates schematically implementation of a look up table of the web server;

FIG. 18 illustrates schematically currency data stored in a look up table of the web server;

FIG. 19 illustrates schematically implementation of data storage for currency data in the web server;

FIG. 20 illustrates schematically a process for generating in real time a calculated cost for filing a trade mark application;

FIG. 21 illustrates schematically a user interface window display of a cost calculator according to a specific embodiment of the present invention;

FIG. 22 illustrates schematically a currency converter window for conversion of currency as a user display at a user interface.

### DETAILED DESCRIPTION OF THE BEST MODE FOR CARRYING OUT THE INVENTION

There will now be described by way of example the best mode contemplated by the inventors for carrying out the invention. In the following description, numerous specific details are set forth in order to provide a thorough understanding of the present invention. It will be apparent, however, to one skilled in the art, that the present invention may be practiced without limitation to the specific details disclosed. In other instances, well-known methods and structures have not been described in detail so as to not unnecessarily obscure the invention. The precise nature and scope of the invention is limited only by the wording of the claims herein.

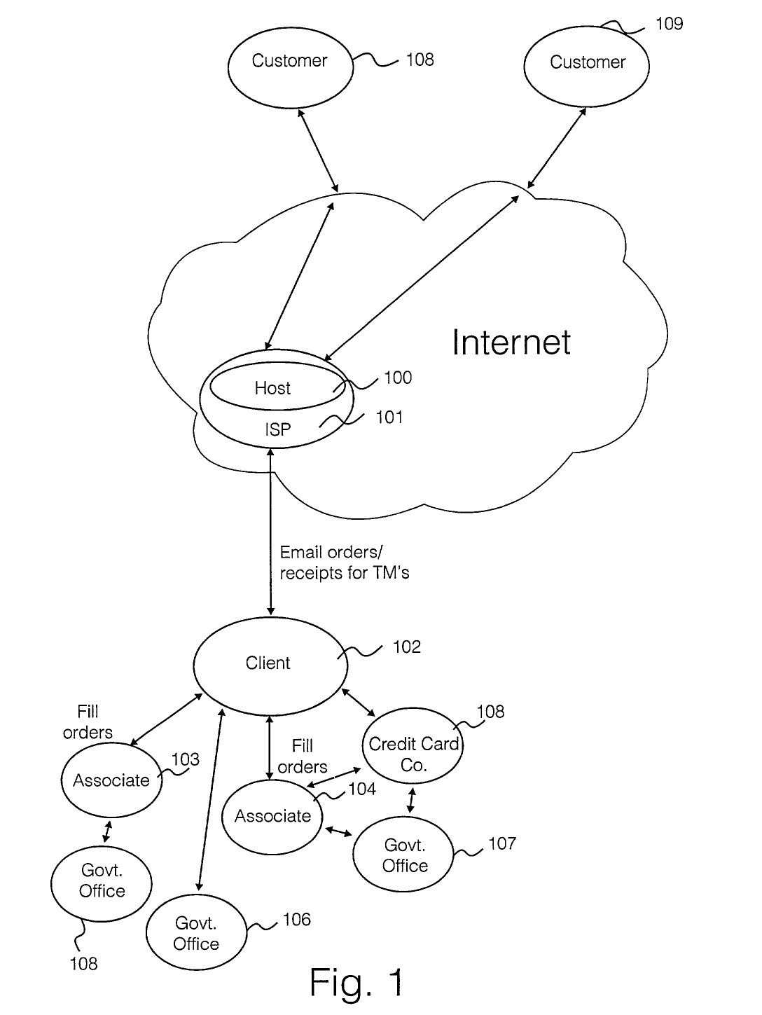

Referring to FIG. 1 herein, there is illustrated schematically a system of co-operating computer entities for providing automated filing of registered trade mark applications at a plurality of governmental or intergovernmental trade mark offices from a plurality of remote locations. The system comprises a host server computer entity 100, for example residing at an internet service provider body 101; a client terminal computer entity 102 in communication with the host server 100 via a dedicated line, for example an ISDN line, or via a virtual private network (VPN), or via the internet; a plurality of associate terminal computer activities 103, 104, communicating with the client terminal 102 and/or the host server 100 via the internet, via one or more VPNs or via one or more ISDN lines; the client terminal 102 and each associate terminal 103, 104 communicating via the internet, via one or more VPNs, or via one or more ISDN lines with a plurality of governmental or intergovernmental terminals 105-107; one or more finance company server computer entities 108 communicating with one or more client terminals 102, one or more subcontractor terminals 104 and/or one or more government office server computer entities 107 via the internet, a VPN or one or more ISDN lines; and a plurality of customer terminal computer entities 108, 109, each capable of communicating with the host server 100 via the internet, a VPN, or one or more ISDN lines.

It will be understood in the general sense that each of the plurality of entities comprising a customer terminal, host server, internet service provider, client terminal, sub-contractor terminal, government or intergovernmental office server or finance company server may be interconnected with each other through any suitable communication medium, including the internet, a virtual private network, one or more land lines, for example ISDN lines, or through wireless links.

In overview, operation of the system is as follows. A plurality of individual customers for trade mark registration and have customer terminals 108, 109. In the best mode, customer terminals are conventional computer platforms or the like, having a web browser and having access to the internet. Customers find the host server 100 using a direct connection or via a known search engine, e.g. Yahoo®, Alta Vista®, Lycos®, Web Top® or the like. The host server 100 presents an interactive web site display to each customer terminal 108, 109 simultaneously and in parallel on demand which is accessed by means of a conventional web browser located at each customer terminal. Through the web site, customers can make data entries at the customer terminals of information required for filing one or more registered trade mark applications in one or more countries as described hereafter. The information is collected as digital customer instruction data, for example in the form of a file, such as a PDF file, by the host server 100, which upon receipt of a ‘proceed’ signal from a customer terminal sends a confirmation message back to the customer terminal that a trade mark application and/or a search has been instructed.

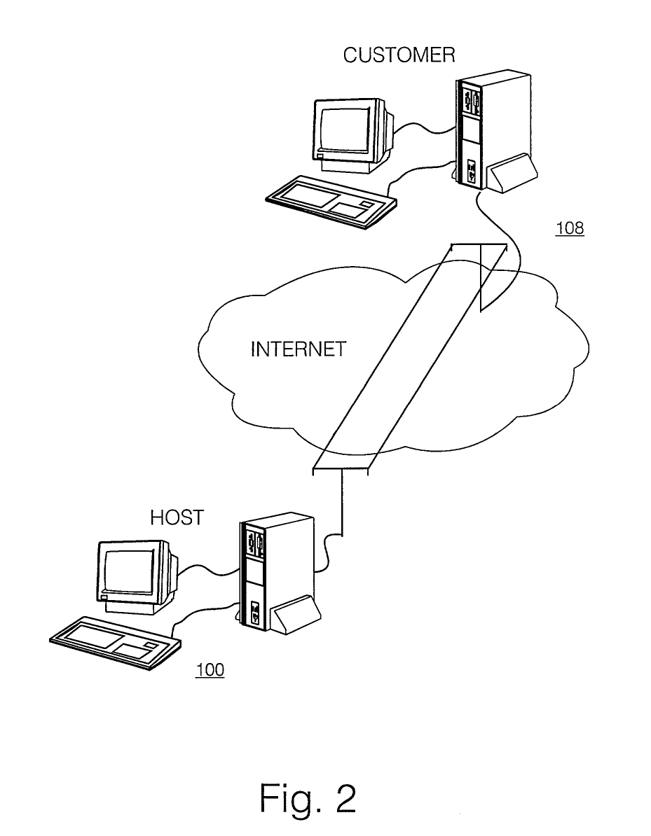

Referring to FIG. 2 herein, there is illustrated schematically individual hardware components comprising a customer terminal 108 and host server 100 connected by an internet communications link.

Host server 100 may comprise a conventional computer platform having a user interface, a keyboard, a modem and internet communications capability, and adapted for acting as a host for an interactive website capable of receiving instructions for filing one or a plurality of registered trade mark applications electronically. Host server 100 preferably has sufficient data processing capability to host a plurality of website displays simultaneously which are viewed by a plurality of customer terminals 108 simultaneously. The host server comprises a visual display unit allowing monitoring of registered trade mark applications to be made by an operator server, or via client terminal 102 with which host server 100 communicates. Each customer terminal 108 comprises a user interface having a visual display unit, a keyboard and a pointing device to enable instruction of a registered trade mark application from a remote location, anywhere on the internet.

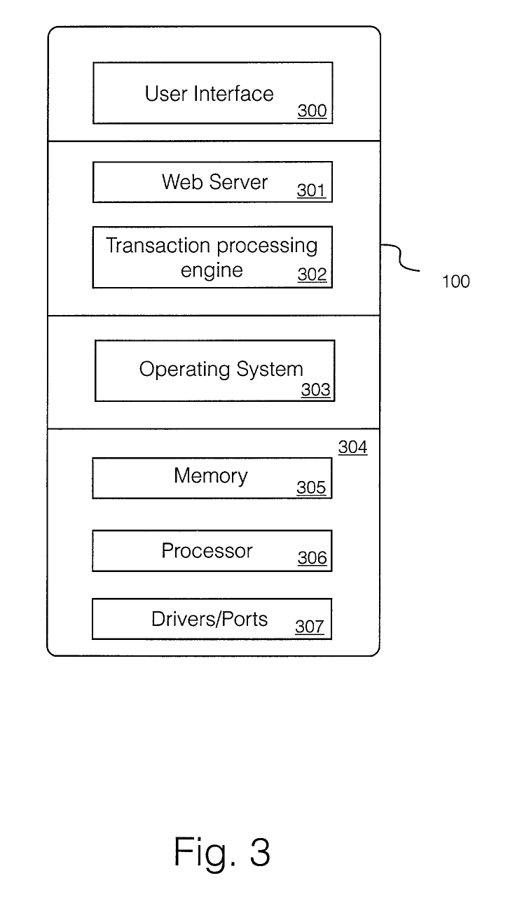

Referring to FIG. 3 herein, there is illustrated schematically components of the host server 100. The hosts server 100 comprises an interface layer 300 in which is provided a user interface, the user interface comprising a visual display monitor, a keyboard for data entry and a pointing device, the user interface capable of generating one or more displays for monitoring of trade mark applications being processed by the host server, and for monitoring data collection and web page displays; a transaction layer comprising a web server 301 operating to display a plurality of interactive web pages for receiving trade mark filing instructions and data, and a transaction processing engine 302 which operates to receive and input instruction data from the web server 301, calculate cost data for real time display by the web server, and provide country and other information displayed by the web server, and send and receive data to and from the client terminal host server 102 concerning the filing of trade mark applications; an operating system 303, for example the known Windows®2000 or LINUX® operating systems; and a hardware/firmware layer 304 comprising a one or more processors 305, memory 306 including RAM, ROM and hard disk memory; and a plurality of drivers and ports 307 including CD ROM writers, printer drivers, USB ports, and one or more modems.

Transaction processing engine 302 uses the underlying operating system and firmware/hardware 305 and user interface 300 to process and manage transactions concerning registration of trade marks, with facilities for interaction and monitoring by a human user.

Transaction processing engine 301 comprises a transaction engine which generates order form data and an order form display, for example in HTML format, which is accessible via web server 301 remotely from one or a plurality of customer terminals 108, 109. The transaction engine presents a sequence of pages of an order form display, which a customer can fill in remotely on-line over the internet for instructing a registered trade mark application. Filling in the form results in an instruction file being created, either at the customer terminal which is sent to the host server, or directly at the host server 100 built up from individual on-line received instructions.

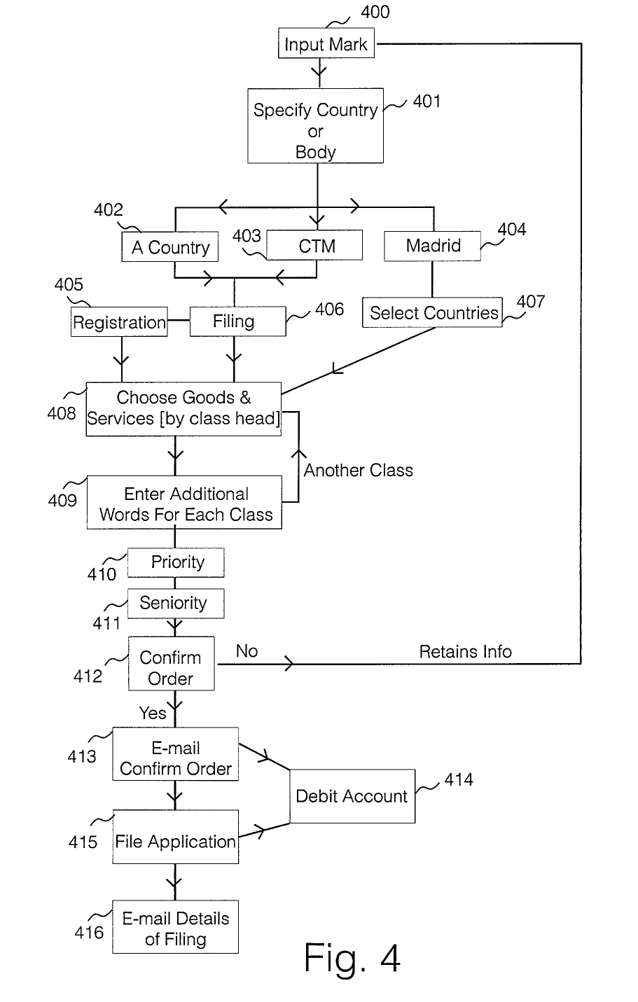

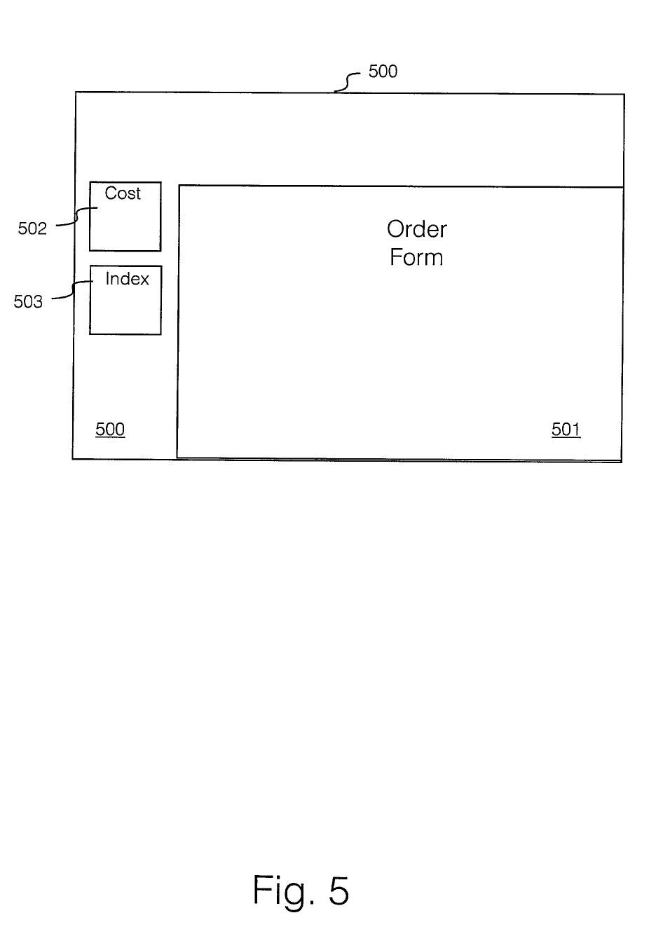

Referring to FIGS. 4 to 12 herein, there is illustrated schematically an overview of an operation of transaction processing engine 302 for collecting data from a customer comprising instructions to file a registered trade mark application. A customer browses the internet, or goes directly via a search engine to find a web site hosted by web server 301. The website displays an order form in the form of electronic web pages which are browsed by the web browser of the customer terminal 108. Web pages are displayed on the user interface of the customer terminal on a screen display as illustrated in FIG. 5 herein. A user inputs instructions into their customer terminal 108, which are relayed to the host server 100 and stored in the form of an instruction file. Transaction processing engine 302 takes the instructions from the file and calculates a real time cost and cost calculator window display, which is made available for view on web server 301 by the customer terminal 108.

Referring to FIG. 5 herein, there is illustrated schematically an overview of a screen display presented at a customer terminal, generated by the host server 100 and viewed by a web browser resident on the customer terminal. The screen display has a perimeter area 500 which is always present and displayed, whichever one of a plurality of pages is displayed in a page display area 501. Different pages can be displayed in page display area 501, and scrolled up or down. Whichever page is displayed, the peripheral margin area 500 remains constantly in view. The margin area 500 contains a cost calculator display 502 which keeps a running total of a cost of a customer's selection of registered trade mark applications, the cost being maintained in real time, and changing as the customer enters or subtracts information and instructions via an order form page present on page display area 501. The cost calculator display keeps a running total of a cost of a current transaction instruction for filing a registered trade mark application, giving a real time display of a total cost of the transaction. The cost calculator may be selected to display the total cost in any one of a plurality of selectable currencies, including preferably the main commercial currencies such as US dollars, Euro and Japanese Yen. Data entered by the customer at the customer terminal for filing one or a plurality of trade mark applications is stored in the host server 100 as a data file. The data file is accessible by the cost calculator for calculating the cost of a trade mark application filing program. Data stored includes number of countries, the country codes for the countries, a list of individual goods and services, a list of classes of goods and services, the number of classes selected, priority details of individual priority claims; seniority details of individual seniority claims; the number of priority claims made, the number of seniority claims made, applicant details, payment details.

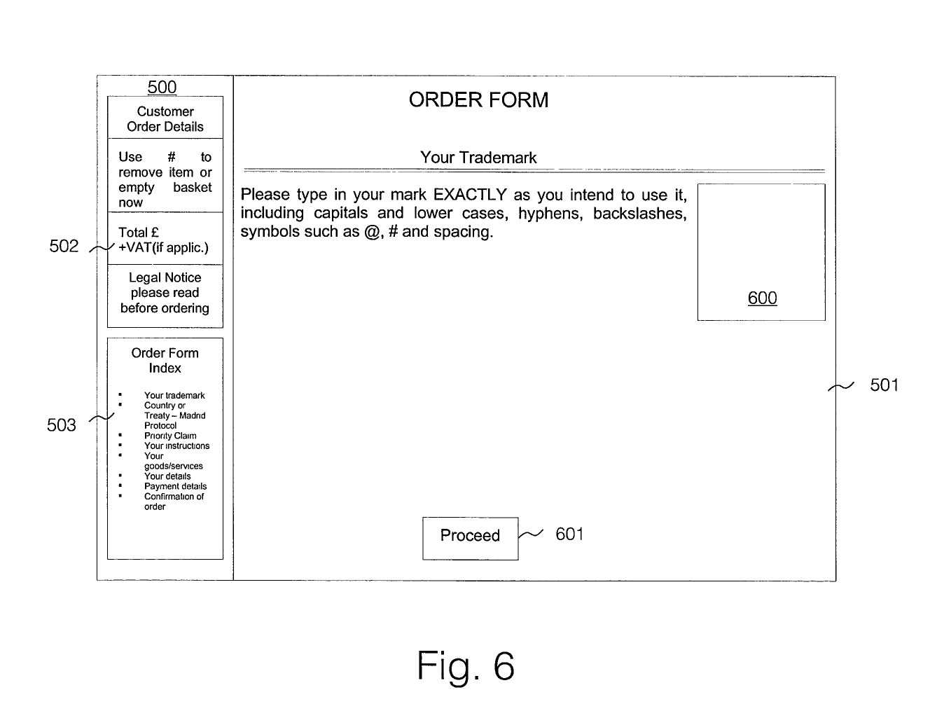

Additionally, there is an order form index list in the margin area 500 which always remains present, enabling a customer to return immediately to any page of the order form without having to scroll the order form through previous pages. The presence of the order form index facilitates use of the order form and makes the filling in of the form more user friendly and less time consuming and enables filling in of the order form in any page order. In step 400, a customer enters through the user interface of the customer terminal the trade mark as it is to be registered, by typing in the trade mark into a dialog box displayed by the web browser resident on the customer terminal as shown in FIG. 6 herein. Data entered by the customer at the customer terminal, is sent over the communications link to the web server which stores the data as an instruction file. Data in the instruction file can change in real time, for example by changing the number of classes of goods selected, changing the number of priorities, changing a selection territories for the mark and changing a selection of seniority claims. The transaction engine uses the data in the instruction file, plus stored data in a look up table to calculate in real time a cost for filing each registered trade mark application for each country, plus a total cost of the complete filing program.

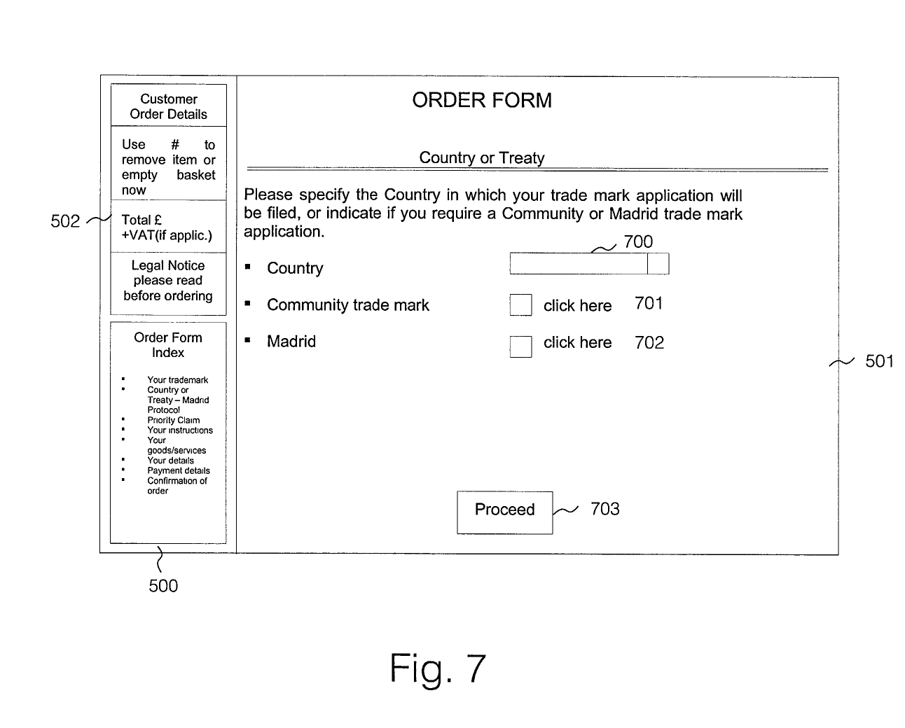

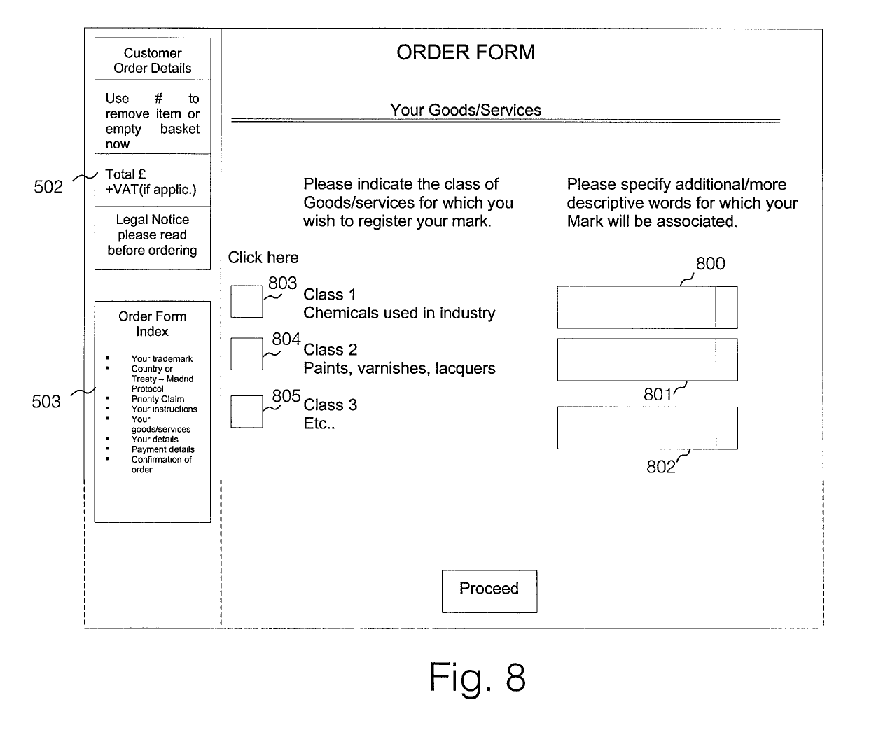

Referring to FIG. 6 herein, there is illustrated a first section 600 of an order form in which a customer enters details of a trade mark which the customer wishes to register in a trade mark dialog box 600. A customer may also import a graphical logo mark in the form of an object or a bitmap, for example prepared in a graphics program such as Corel®, by storing the object as a file in a graphics application, and then dragging and dropping the file icon into the dialog box 600. The customer then activates proceed icon 601 or scrolls the order form page to proceed with filling in the order form. Typically, for a word mark this will include a word in a conventional typeface and may include characters such as ?, *, #, @, !, % &. The characters may be input as capitals or a mixture of capitals and lowercase. On correctly entering the details of the mark, the customer activates a ‘proceed’ icon 601 to proceed to the next section of the order form as shown in FIG. 7 herein. In step 1401, the customer specifies a country or region for filing of a trade mark application. Referring to FIG. 7 herein, the order form presents a dialog box 700 for entering a country. A country/treaty section of the order form as shown in FIG. 7 is displayed by web server 301, having data entry fields 700 for entering a country, selecting a regional trade mark system such as the community trade mark system 701, or a Madrid Protocol trade mark application 702. The country selection box 700 comprises an icon-activated dropdown menu listing a plurality of countries. A customer selects a particular country by scrolling to that particular country, and activating selection of that country by, for example, a double-click on the pointing device whilst a pointer icon is over the selected country. The user can select in step 402 any one of a plurality of countries, in step 403 a community trade mark by activating the community trade mark selection box 601, and/or a Madrid trade mark application by selecting the Madrid Protocol selection icon 702 in step 404.

The user may enter the name of the country or may select a country code from a dropdown menu activated by double-clicking on the dialog box 700. The user may select one or a plurality of countries in which to register the trade mark entered in mark dialog box 700. If the user selects an individual country from the country selection box 700, or the community trade mark box 701, the user then activates a proceed icon 703 by placing the pointer icon over the proceed icon and double-clicking the pointing device. The customer then activates proceed icon 703 or scrolls the order form to continue data entry.

In step 405, a customer fills in a further dialog box on a further web page for instructions (not shown) in which options are presented for registration of a mark or registration and filing of a mark in step 406.

Referring to FIG. 8 herein, in step 408 a customer may enter a list of goods/services in a plurality of goods/services dialog boxes 800-802, for which the trade mark is to be registered. Data entry via any one of the goods/services dialog boxes 800-802 results in a corresponding class confirmation box 803-805 showing a positive indicator, for example a tick icon, indicating that goods and services in that class have been entered. If a customer wishes to designate all goods and services according to an international classification system in a particular class, the customer may only need to click on the classification confirmation icon 803-805 to select all goods and services in that class. Additional description of goods/services may be entered in step 409 by typing in text characters in the dialog boxes 800-802.

Cost calculator icon 502 maintains a cumulative display of the cost of the currently specified trade mark filing options. That is to say the cost of filing a registered trade mark application in the selected country or countries, having goods and services as specified by the customer falling into the corresponding classes indicated by the class confirmation icon 803-805. Because the cost of filing a registered trade mark application in general varies depending upon the number of classes of goods and services for which the mark is applied for, deactivation of a class confirmation icon 803-805 by deletion of goods in that class may change the total cost, i.e. reduce the cost, as displayed by the cost calculator display 502. Similarly, specifying more goods and services in more classes or confirming more classes by clicking on further class confirmation icons will increase the total cost displayed in the cost calculator display 502. Therefore, the customer may add or delete classes of goods and services by confirming or deleting classes by activation or deactivation of the class confirmation icons 803-805.

De-selection of classes of goods and services has an effect on the scope of protection afforded by a registered trade mark application in a particular country. To reduce cost a customer may choose to have a comprehensive class coverage in particular countries, with less comprehensive class coverage, or no class coverage in other countries. The customer may scroll the order form back to the country selection section as illustrated with reference to FIG. 7 herein and de-select individual countries in order to reduce costs. Thus, the customer if faced with a limited budget is allowed the flexibility to interactively modify his selection of country and class of goods/services to achieve optimized protection within a budget, by interactively and in real time modifying the selection of goods and services and countries using dialog data entry boxes on the order form page. At all times, the cost calculator 502 displays a real time calculation of the total cost of the filing program entered by the customer. The customer may explore interactively the effect of addition/deletion of different countries or addition/deletion of different classes of goods/services on the total cost of the filing program by selecting/de-selecting countries and/or goods and services and watching how the total cost of the filing program varies as displayed on the cost calculator window 502.

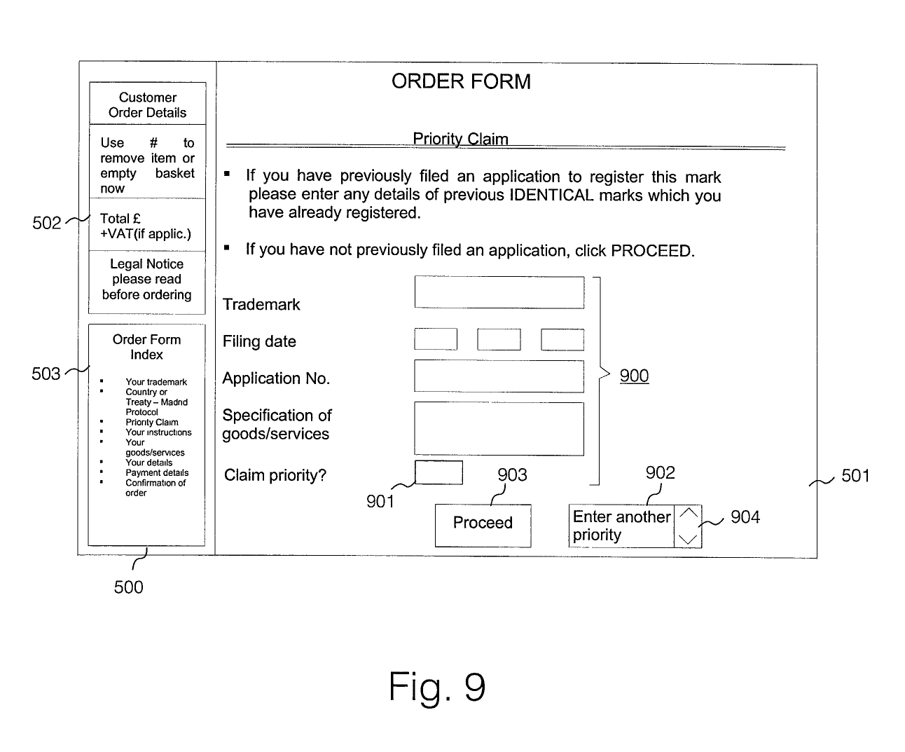

Referring to FIG. 9 herein, in step 410 there is illustrated a priority claim data entry section of the order form. The priority claim section comprises dialog boxes 900 for entering details of a priority application from which a customer may wish to claim priority for his trade mark filing program. Dialog boxes for the priority mark, the priority filing date, the priority application number and the goods/services of the priority application are included. A customer may fill in the priority data as one exercise and then decide whether or not to claim that priority by activating a claim priority instruction icon 901.

Having entered a first priority application, the customer may repeat the exercise for second or subsequent priority claims. A new set of empty dialog boxes are displayed upon the customer activating an ‘enter another priority’ icon 902. The customer may scroll through already entered priority details to check those details by using priority scroll function available through a displayed scroll icon 904. To proceed to the next part of the order form, the customer activates proceed icon 903.

By activating or deactivating a priority claim, the customer may explore the cost consequence of claiming or not claiming a priority in the selected country or countries of application.

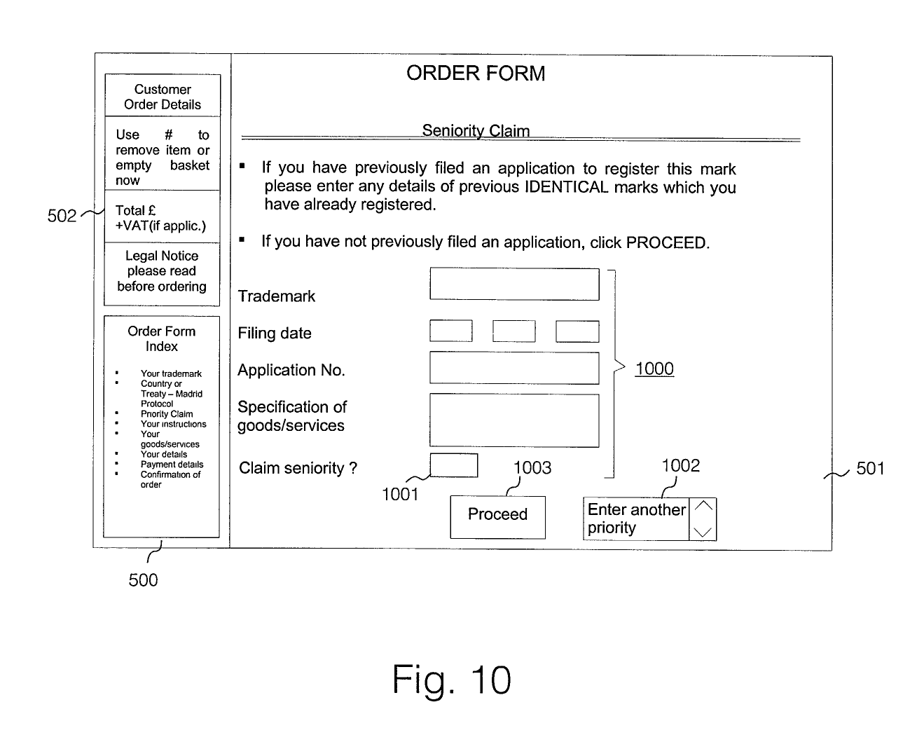

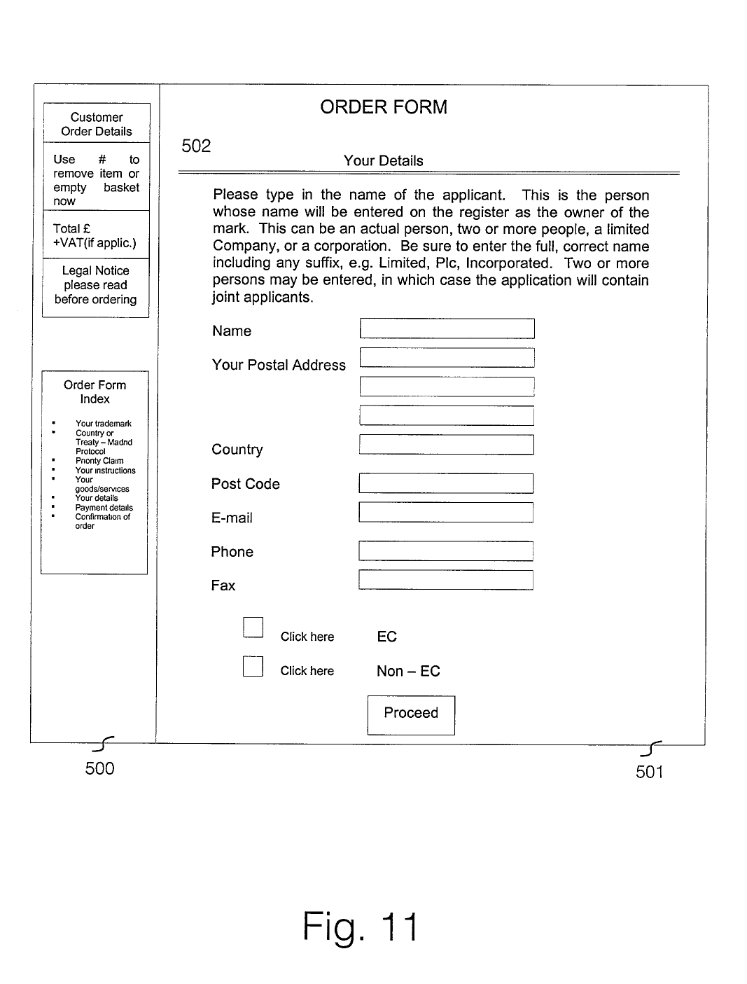

Referring to FIG. 10 herein, a customer may claim one or more seniorities. Seniorities only apply to European regional trade mark applications. Filling in of the order form from a customer's point of view for claiming seniority is similar to filling in the priority claim part of the order form as described herein.

The customer is presented with a plurality of dialog boxes 1000 specifying seniority country, seniority trade mark, seniority filing date, seniority application number and specification of goods/services for a seniority mark. The customer may specify that the seniority is or is not claimed by toggling a ‘claim seniority’ icon 1001. Where more than one seniority is to be claimed, a customer may, after having entered details of a first seniority filing, enter details of second and subsequent seniority filings by activating an icon 1002 for claiming another seniority, which results in a refreshed display of a set of seniority claimed dialog boxes 1000. A customer may toggle through the different seniority claims by toggling the ‘another seniority’ box 1002, so that any data entries may be corrected, or any instructions for claiming or not claiming the seniority may also be altered.

Depending upon the selection of seniority, the cost calculator keeps a running total of the total cost of the trade mark application filing program.

Referring to FIG. 11 herein, there is illustrated schematically a set of dialog boxes in which a customer may enter his name, postal address, country and contact details.

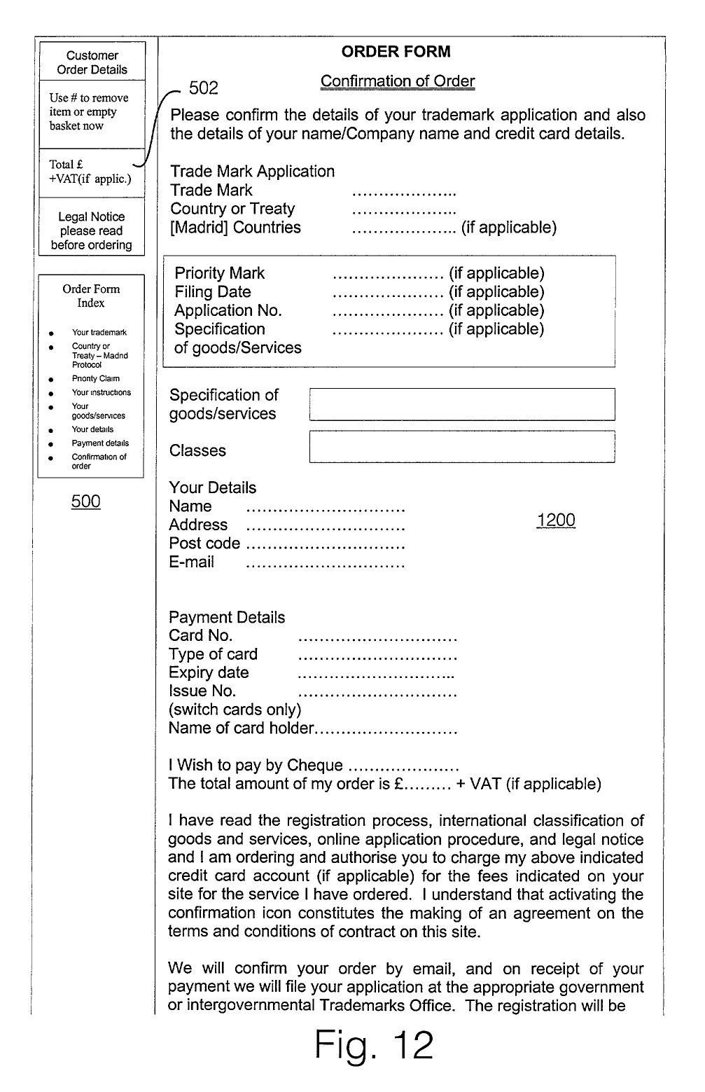

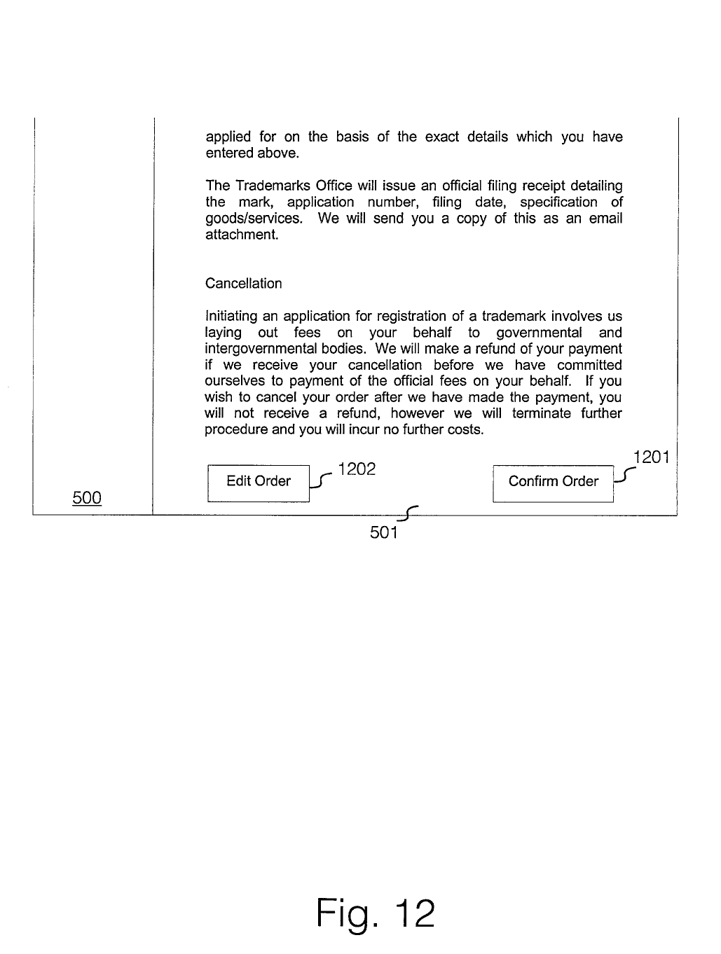

Referring to FIG. 12 herein, there is illustrated schematically a confirmation of order page display 1200 in which a filing program instructed by a customer is displayed in total, prior to the customer proceeding to confirm the filing. The confirmation of order contains details of trade mark, individual countries, one or more priority claims, including details of the priority mark, priority date, priority application number and specification of goods/services of the priority applications; a specification of goods/services for the mark and a list of classes, one or more seniority claim details including seniority country, seniority date, seniority goods/services, and seniority application number.

The confirmation of order page 1200 also confirms the customer's details and also payment details by which payment is to be made. A legal notice is contained in the confirmation of order, and an icon 1201 for confirming the order is activated once the customer is content with the order.

If a customer wishes to edit the order, then s/he can do so at any time by activating an edit order icon 120 and changing any of the details displayed on the confirmation of order form. Alternatively, the customer may select a different order form page from the order form index display 503 which is present in the margin area 501 at all times, and edit data on that page.

As the customer navigates any part of the website, at all times s/he may switch to previous page sections of the order form, navigating the website via order form section display icon 503. Since the order form icon 503 is always present, this avoids the need for the customer to scroll up or down on the order form or scroll back through previous pages in order to reach any previously accessed page. Further, the customer may skip forward and fill in the order form in any page order desired, by selecting those pages from the order form navigation icon 503. This feature greatly enhances the usability of the order form from the customer's point of view.

Underlying functionality and architecture of the cost calculator display 502 will now be described.

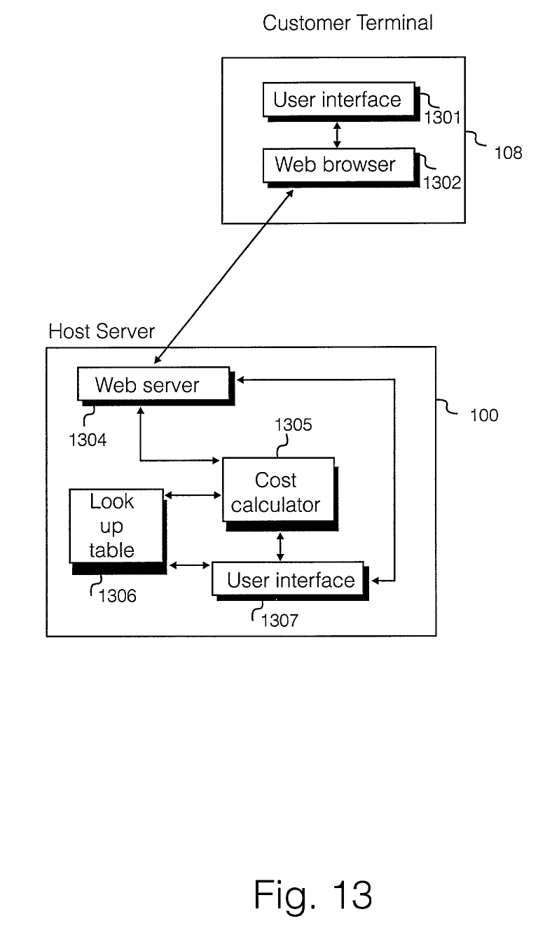

Referring to FIG. 13 herein, the customer terminal 108 comprises a user interface 1301 having a visual display unit, keyboard data entry means and pointing device, for example a mouse, and a web browser 1302 capable of connecting to host server computer entity 1303. Host server computer entity 100 comprises a web server 1304, a cost calculator engine 1305, a look up table 1306, and a user interface 1307, the user interface comprising a visual display unit, a data entry keyboard for entry of text data and a pointing device, for example a mouse.

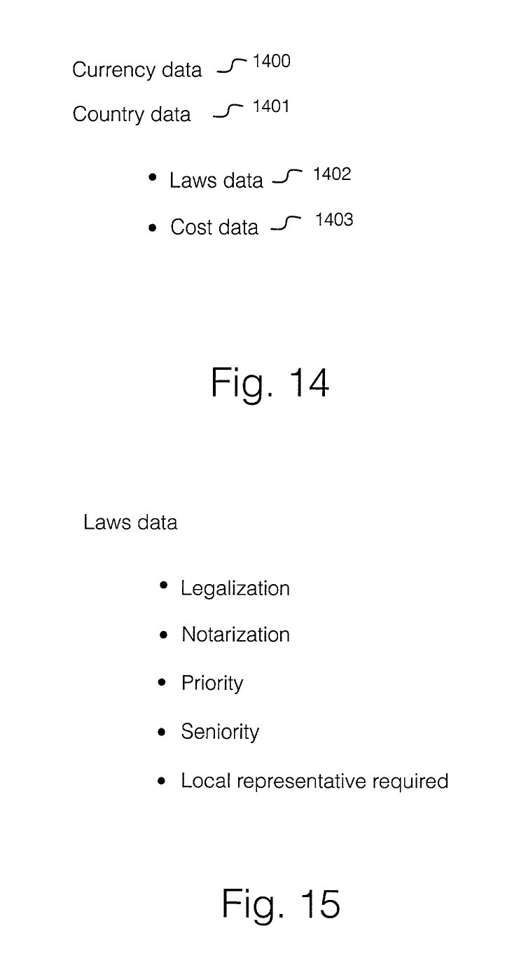

Referring to FIGS. 14 to 19 herein, there is illustrated schematically types of data contained in the look up table 1306. Stored data includes currency data 1400 and country data 1401. For each country, there is stored a country data comprising data sub-types of a law data 1402 and a cost data 1403. The law data describes the relevant laws in the specified country which have a bearing on the cost of filing a trade mark application. Although there is much commonality of law from country to country due to signature of those countries to international conventions, in the general case, the laws on filing registered trade mark applications differ from country to country. For example, some countries may require, by law, a local trade mark agent of a local lawyer to handle a trade mark application, some countries may require legalization or notarization of documents whereas others may not, some countries may accede to the Paris Convention for the protection of intellectual property, in which case priority claims can be made, whereas other countries may not. Some countries may allow a seniority claim from earlier trade mark applications, whereas other countries may not. The data stored in the laws database is used to determine whether or not a cost consequential on that law should be added to a cumulative total for filing a registered trade mark application in that country.

Referring to FIG. 15, examples of such law data sub-types include: whether a local agent is required under the national law to file the registered trade mark application; whether notarization of documents are required; whether legalization of documents are required; whether a certified priority document is required; whether a certified seniority document is required; whether seniority can be claimed; and whether priority can be claimed.

For each country, the cost of filing a trade mark application depends on 3 basic factors being: fees payable to a government body; fees payable to a local associate agent; and fees charged by the vendor, running the website. As far as the vendor is concerned, official fees and associate fees are treated as disbursements, that is money to be paid out. The value of the trade mark filing instruction to the vendor is the difference between the cost which the customer pays, and the disbursement element.

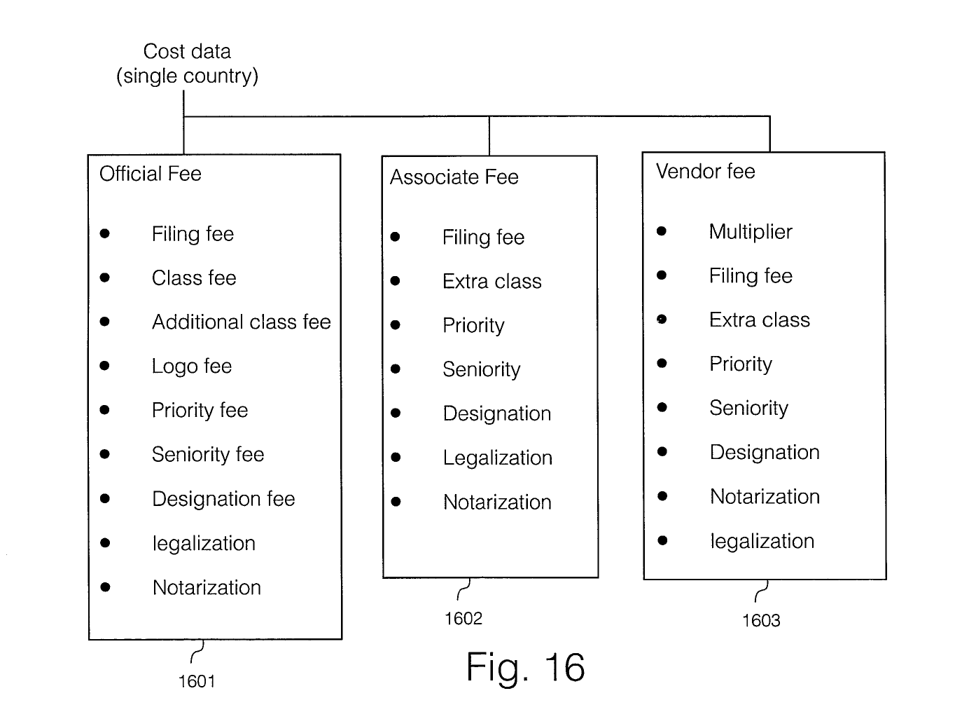

Referring to FIG. 16 herein, there is illustrated schematically, for a single country, classes of component cost data for that country. The classes of component costs include: an official fee class 1601, an associate fee class 1602, and a vendor fee class 1603. Sub-classes of official fee data 1501 include all the different types of official fee which can be charged in that country. These comprise filing fee, class fee, additional class fee, fee for a logo mark, priority claim fee, a seniority claim fee, a designation of state fee and a legislation fee and a notarization fee. In addition to official fees, associates may also charge standard or fixed scale fees which vary from associates to associates for their service in handling the application. Sub-classes of subcontractor fee data includes filing fee charge, extra class charge, priority claim charge, seniority claim charge, legalization charge, notarization charge and designation of state charge.

Similarly, the vendor running the website may base his fee scale on individual items of work such as paying a filing fee, designating classes, claiming a priority, etc. Sub-classes of the vendor fee class data 1603 include a vendor filing fee, a vendor extra class fee, a vendor priority claim fee, a vendor seniority claim fee, a vendor designation of state claim fee, a vendor notarization fee and a vendor legalization fee.

Because the task of setting the actual amounts of individual fees from first principles is a complex task, a vendor may take the view that the whole of the official fees and associate fees for a trade mark application constitutes a disbursement, and the vendor will simply apply a fixed multiplier to that disbursement cost, which becomes the cost quoted to the customer on the webserver. Therefore, as a sub-class of vendor fee 1603, a vendor may simply insert a multiplier, being a percentage mark-up of the disbursement. Typically such mark up will be in the range 10% to 300%, and more likely be in the range 20% to 100%. The vendor may vary the multiplier for each individual country, for example if the vendor is experiencing competition from competing websites in the US, the vendor may lower his multiplier compared to other countries, for the country US only. In countries where the vendor is experiencing less competition, or for where there are few websites available for filing applications in that country, the vendor may select a higher, multiplier for that particular country.

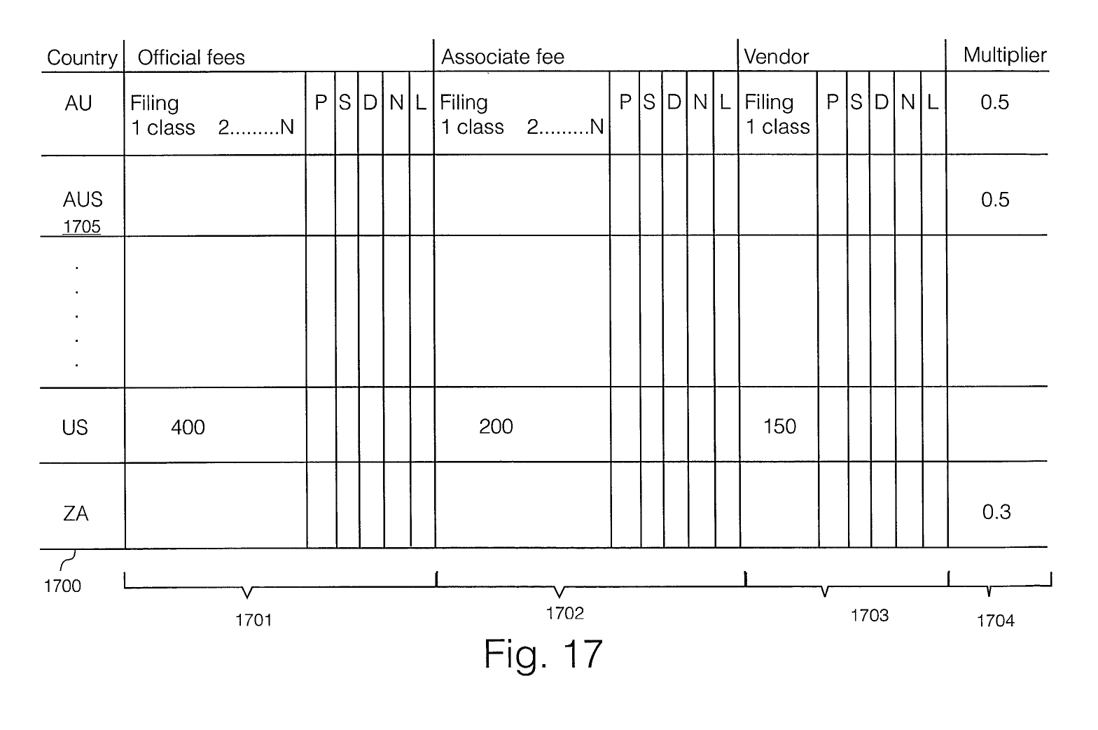

Referring to FIG. 17 herein, there is illustrated schematically a practical implementation of look up table 1706. All classes of country data may be contained in a single database laid out for example in rows and columns, where each column relates to a sub-class of data for a particular country, and each row specifies a country. Countries may be designated in a first column 1600 of the database by internationally standardized two or three letter country codes, for example GB, ZA, US. Official fees may be grouped into a first plurality of columns 1601, associate fees may be grouped into a second plurality of columns 1602, and vendor fees may be grouped into a third group of columns 1603. Each of the official fees group, subcontractor fee group, and vendor fee group of columns may have individual columns relating to the individual subclasses of the official fee class, subcontractor fee class, and associate fee class as illustrated in FIG. 16. Particular instances, i.e. actual costs may be entered in a single currency, for example US dollars. Separate columns may be provided for each of official filing fee (single class), official filing fee first extra class, official filing fee second extra class, up to official filing fee nth extra class; official fee for priority claim; official fee for seniority claim, official fee for designation of state; official fee for notarization, official fee for legalization. Similarly, individual columns may be provided for each sub-class of associate fee, including associate filing fee, associate extra class fee, associate priority claim fee, and so on as illustrated schematically as an associate sub-class data group 1702 in FIG. 6 herein.

The cost calculator uses as inputs, the data stored in the look up table for a particular country, along with the instruction data inputted by a user and stored as an instruction data file at the web server, the instruction data being used to select which country, and which optional items, for example classes, seniority, priority are to be selected from the look up table as an input into the transaction engine.

A human operator at user interface 1207 of the host server 1303 may access the database in the look up table 1206 and modify any individual data entry in the database. For example, if a human operator wishes to modify the mark-up of 50% on an Australian trade mark application, then the multiplier data 0.5 in multiplier column 1704 corresponding to the row for an Australian trade mark application 1705 may be altered to a different multiplier, e.g. 0.4 (40%).

Further, the associate fee column group 1702 in general will represent prices from a plurality of different associates, in the extreme case one per different country or region. There may be provided further groups of associate columns, to allow for a selection of different associates in a same state. For example, each of a plurality of different associates may have a group of columns for filing, priority, seniority, designation, notarization and legalization fees.

A human operator may obtain data from different associates concerning changes in their prices and fees, and monitor and maintain the individual costs entered as data in the associate group columns 602. The provision of a plurality of different columns for associate groups may allow the human operator to select, on the basis of cost, a particular associate upon which the cost calculator bases the cost calculation. In this way, the human operator may balance the prices quoted on the cost calculator to the customers, with the use and selection of individual associates on a cost basis.

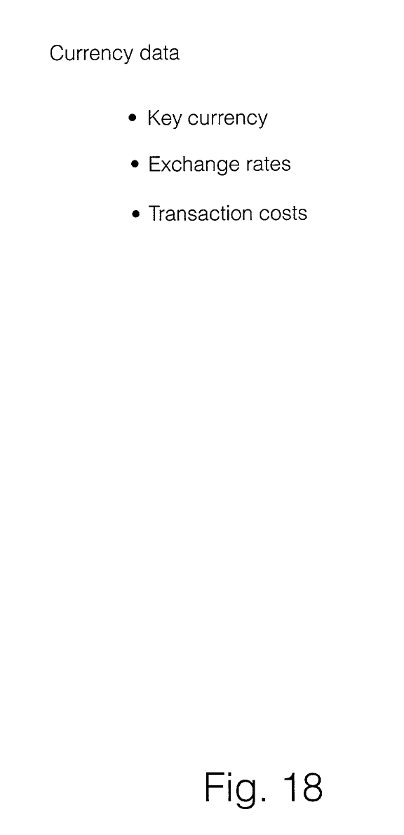

Referring to FIG. 18 herein, there are illustrated sub-classes of the currency data class. Currency data comprises a key currency, being a currency specified by a vendor as a default display currency which will be displayed on the cost calculator in the absence of a customer requesting a different currency, and also being a currency in which a vendor prefers to receive payment; an exchange rate data; and a transaction cost data. The key currency data may normally be specified in the currency of a state or nation in which the vendor resides. For example, a US vendor may specify US dollars as the key currency, since many customers in US time zones will also prefer to make payment in US dollars, and receiving payment in US dollars will avoid various transaction costs on the part of the vendor. However, the cost calculator gives the option of payment in a different currency to a customer, in which case, in order to avoid losing money, the vendor must calculate the cost of the transaction including loses due to exchange rates and transaction charges.

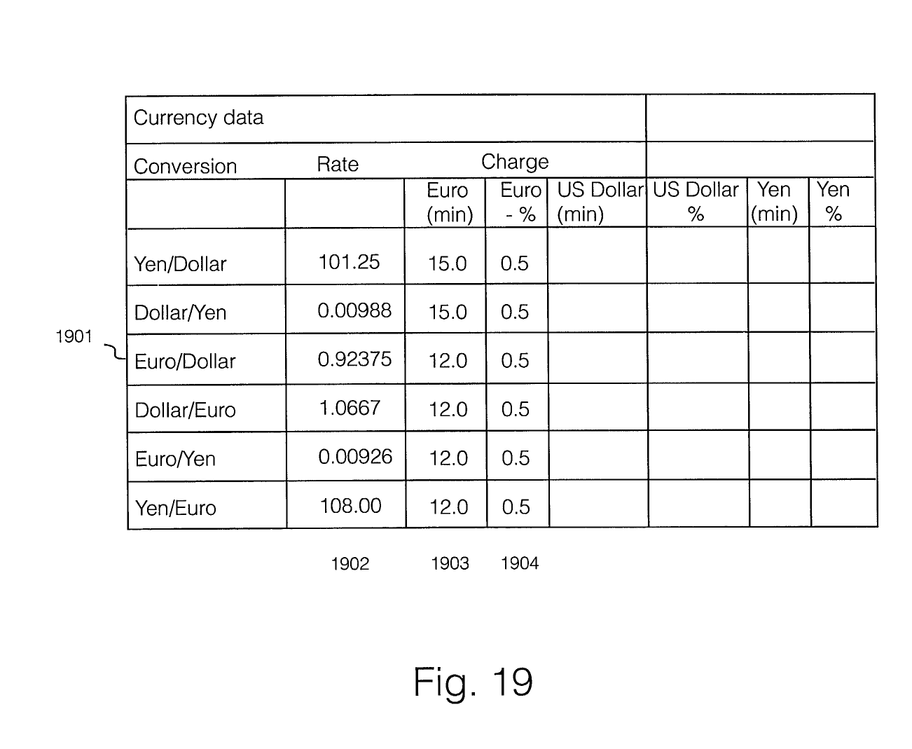

Referring to FIG. 19 herein, there is illustrated a look-up table data containing the currency data as described with reference to FIG. 18. In the look-up table, exchange rates and bank charges for conversion of currencies are tabulated in rows and columns. Each row specifies a conversion from a first currency to a second currency, for example from Euro to US dollar, row 1901. For this conversion, a rate of conversion is given in a second column 1902, a minimum transaction cost for a conversion is given in a third column 1903, and a percentage transaction cost is given in the fourth column 1904. From this, the cost calculator can calculate the cost of transacting any amount of Euro to an equivalent amount of dollars, taking into account exchange rates and bank charges levered on the transaction to the vendor.

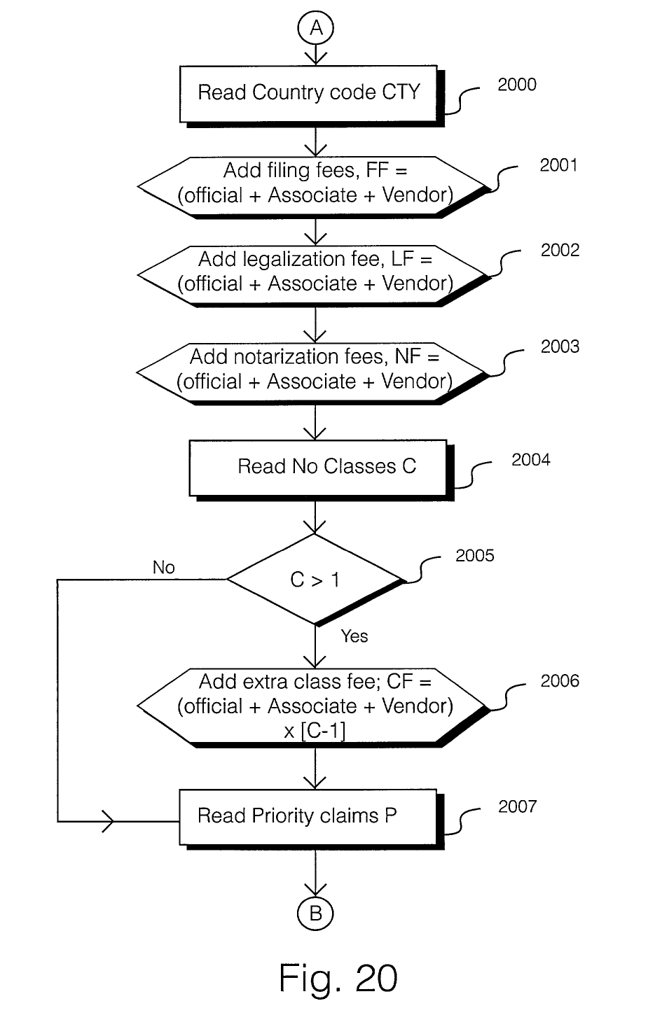

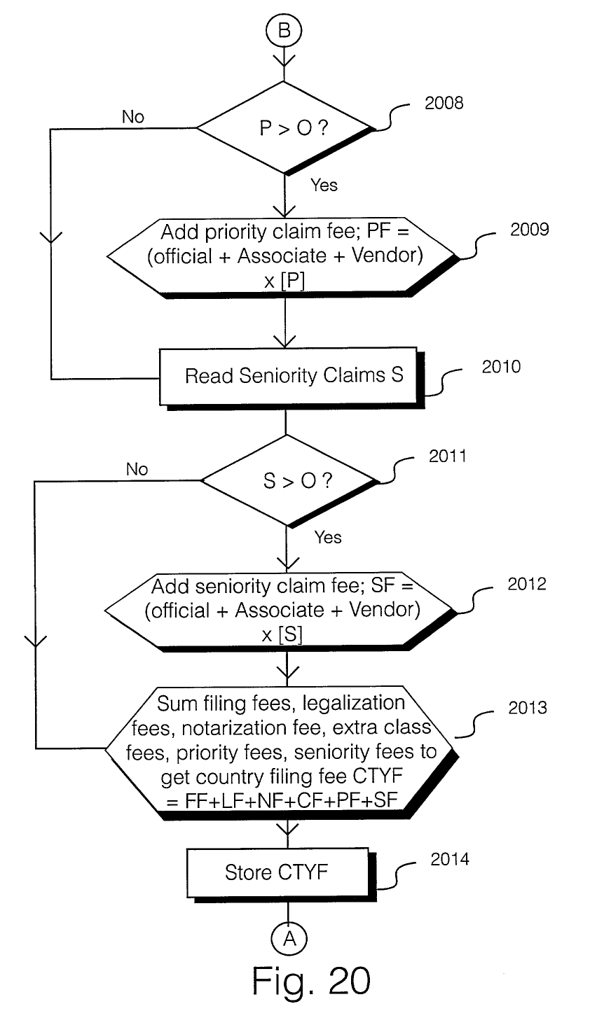

Referring to FIG. 20 herein, there is illustrated schematically process steps carried out by cost calculator 1305 for generating a cost display representing the total cost CTYF quoted for filing a registered trade mark application in a single country. The total cost CTYF takes into account different classes of goods and services, whether legalization, notarization are required in a particular territory, whether a priority claim and/or seniority claim are made, including the number of those different claims, associate fees, official fees and vendor fees charged. The total cost CTYF is calculated in the key currency specified by the vendor, which is also the currency in which instances of cost data are entered into the look-up table 1306 representing official fees, associate fees and vendor fees.

In step 2000, the cost calculator reads from the web server a country code entered by a customer via the customer user interface 1301 and customer web browser 1302. In step 2001, cost calculator 1305 refers to the look-up table 1306 to calculate filing fees FF. The filing fee FF is summed by the cost calculator to equal the official filing fee, the associate filing fee, and the vendor's filing fee. These are read from the appropriate row and column entries in the look-up table as illustrated in FIG. 17 herein. For example, for filing a US trade mark application the filing fee may be calculated as official fee $400, associate fee $200 and vendor fee $150, giving a total of $750 USD. This assumes no priority claim and only a single class of goods and services.

In step 2002 the cost calculator looks in the appropriate legalization fee columns for official fee, associate fee and vendor fee for the country specified, and depending upon the entry in the two-dimensional look-up table 1700 there either may or may not be a charge for legalization in the particular country selected. Whether or not legalization is required in a particular country is specified by the absence or existence of an official fee, associate fee and vendor fee in the look-up table. Where no legalization is present, a vendor may simply enter 0 as the official, associate and vendor legalization fees for that particular country. On the other hand, where legalization is required, to avoid making a systematic loss on the transaction, the vendor must enter the official fee, associate fee and vendor fee for performing the legalization operation. The legalization fee LF is calculated as the official legalization fee, the associate legalization fee and the vendor legalization fee.

In step 2003, the cost calculator sums the notarization fees, reading these from the look-up table 1306. Where notarization for a particular country is not required, the value of the official, associate and vendor notarization fees are set to 0 in the look-up table. The cost calculator adds the notarization fee NF being the total of the official, associate and vendor notarization fees, to a running total.

In step 2004, the cost calculator reads the number of classes C input by the customer.

In step 2005, it is checked whether the number of classes C is greater than 1. If the number of classes specified is not greater than 1 (i.e. is 0), then the cost calculator may generate a signal for display of a reminder icon, reminding a customer to specify at least one class of goods and services. If the number of classes C is greater than 1, then this means that additional class fees may be applicable. In this case, the cost calculator in step 2006 sums the fee CF for filing the application with additional classes over and above 1. These are summed as the associate class fee, the official extra class fee and the vendor extra class fee, times the number of classes C minus 1. This total cost is added to the running total. In step 2007, the cost calculator reads the number of priority claims P specified in the stored data file by the customer. If P is greater than, that is to say if priority is claimed, then additional fees may be payable. It is checked whether P is greater than in step 2008. If P is not greater than 0 (i.e. is 0) then the algorithm proceeds to read a number of seniority claims S in step 2010. However, if P is greater than 0, then extra priority claim fees PF may be applicable and the cost calculator sums these by reading the official priority fee, associate priority fee and vendor priority fee for the particular country from the appropriate columns of the look-up table, and multiples these by the number of priority claims P. The cost of the extra priority claims PF is added to the running total. The cost of the extra priority claims PF is added to the running total.

In step 2010 the number of seniority claims S is read by the cost calculator. It is checked whether S is greater than 0 in step 2011. If S is not greater than) (i.e. there are no seniority claims) then the algorithm proceeds to step 2013. However, if S is greater than 0, then an extra cost for claiming seniority SF is calculated in step 2012. The cost of calculating extra seniorities is the official fee cost, plus associate fee cost, plus vendor cost for a seniority claim read from the appropriate columns of the look-up table, multiplied by the number of seniority claims S. The sum total of seniority claims SF is added to the running total CTYF of the cost of the application in that country. In step 2013, the running total is calculated as the sum of the filing fees, legalization fees, notarization fees, extra class fees, priority fees and seniority fees to get the country filing fee CTYF where:

CTFY=FF+LF+NF+CF+PF+SF

In step 2014, the running total CTYF is stored.

As will be appreciated by those skilled in the art, the sum total of filing application CTYF may be stored as a running total throughout steps 2000 to 2014, as a variant of the algorithm.

For each country, the cost calculator continues to traverse the loop 2000-2014, in order to maintain the running total. At any time, the customer may change the input data, for example the number of classes C, the number of priorities P and the number of priorities S may verify, all of which will vary the total cost CTYF for that country. Additionally, a customer may deselect the country altogether, in which case the country code CTY disappears and CTYF is automatically set to 0 (because no application is proposed to be filed in that country).

For each country specified by the customer, the cost calculator continuously, and in real time, lops the algorithm as illustrated in FIG. 19. The total cost for all countries displayed in cost calculator display 503 is the sum of CTYF for each country.

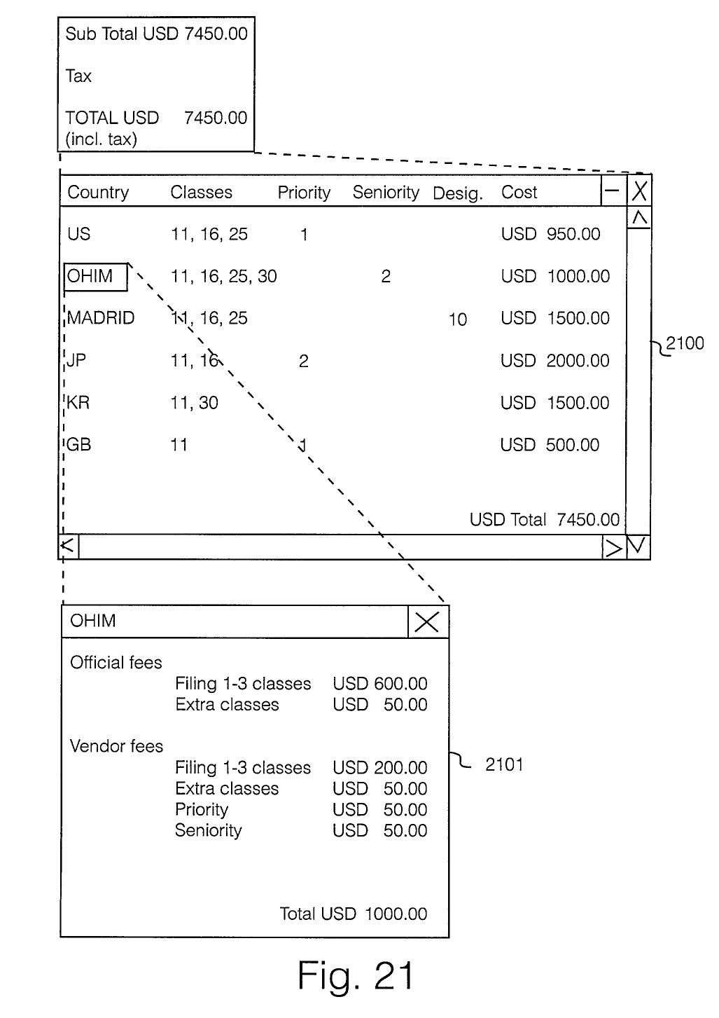

A customer may interactively change the selection of countries, whether or not priorities are selected, whether or not seniorities are selected, and the goods and services for each trade mark application is each country. In order to provide a summary of the current filing instruction, and also give further information on costs, a customer may expand the cost calculator window 503 into an expanded cost calculator window 2100 as shown in FIG. 21 herein.

In the expanded cost calculator window 2100, there is listed the current customer selection of countries, classes, priorities claimed, seniorities claimed and the total cost for each country denoted in the key currency. As illustrated in FIG. 21, the expanded cost calculator display 2100 comprises a plurality of rows and columns. For each row, a country code is specified in a first column, followed by the classes of goods and services for which the customer will instruct trade mark filing for that country, followed by whether a priority is claimed, and if so the number of priorities claimed, whether a seniority is claimed, and if so the number of seniorities, followed by a fifth column designating the total cost of filing the application in that country. A summation of the fifth column, that is to say the sum total of each of the filing costs for each country, is provided at the bottom of the fifth column. In the example shown in FIG. 21, a filing program for the US, OHIM, Madrid, Japan, Republic of Korea and the United Kingdom of Great Britain is shown, where different classes of goods and services are specified for each country, and priorities are not the same in each country and seniorities are not the same in each country. The class column lists the actual numbers for which the application is to be filed in a particular country.

The customer may alter any of the data in the expanded cost calculator window 2100 by simply overtyping new data on that display, after first positioning a text icon over that display and activating a pointing device, e.g. a mouse. For example, if a customer wishes to delete class 25 from a US trade mark application, the customer may highlight the number 25 in the class column of the expanded window display 2100 and press a delete button. The transaction engine automatically reads this expanded cost calculator window display and makes the appropriate deletion to the underlying data file. The cost calculator, which takes its data from the data file in real time re-calculates the cost of the trade mark application, and modifies the resultant cost to CTYF for the US trade mark which in turn modifies the displayed cost in the fifth column in the expanded cost calculator display 2100.

By double-clicking a pointer icon over an individual country indicator in the first column of the expanded cost calculator window 2100, as shown in first expansion window 2101 a breakdown of the fees applied may be shown in breakdown window 2101. The breakdown shows the proportion of official fees, vendor fees and associate fees where applicable which make up the total cost of filing the trade mark application. For example, for a OHIM trade mark, the official filing fee for goods/services in 1 to 3 classes may be $600 and an extra official class fee $50. A vendor filing fee for the first 3 classes of $200 and an extra class fee of $50, two seniority fees of $50 each are shown. A customer may then decide which optional items are deleted in order to reduce the cost. For example, the customer may choose to either not claim seniority thereby saving $100 USD, and/or delete one of the classes, thereby saving a further $100 USD. Of course, some of the items cannot be deselected without abandoning the whole filing. For example, where a legalization or notarization fee is shown and that is a legal requirement for filing and prosecuting the application, this would not be deleteable. Fees which are optional are provided with a flag indicating that they are deleteable in the look-up table. Fees which are not deleteable without deleting the whole application are provided with a second flag indicating they are not deleteable. Where a customer attempts to delete a non-deleteable fee, the display may display a messages such as ‘cannot delete without abandoning application’.

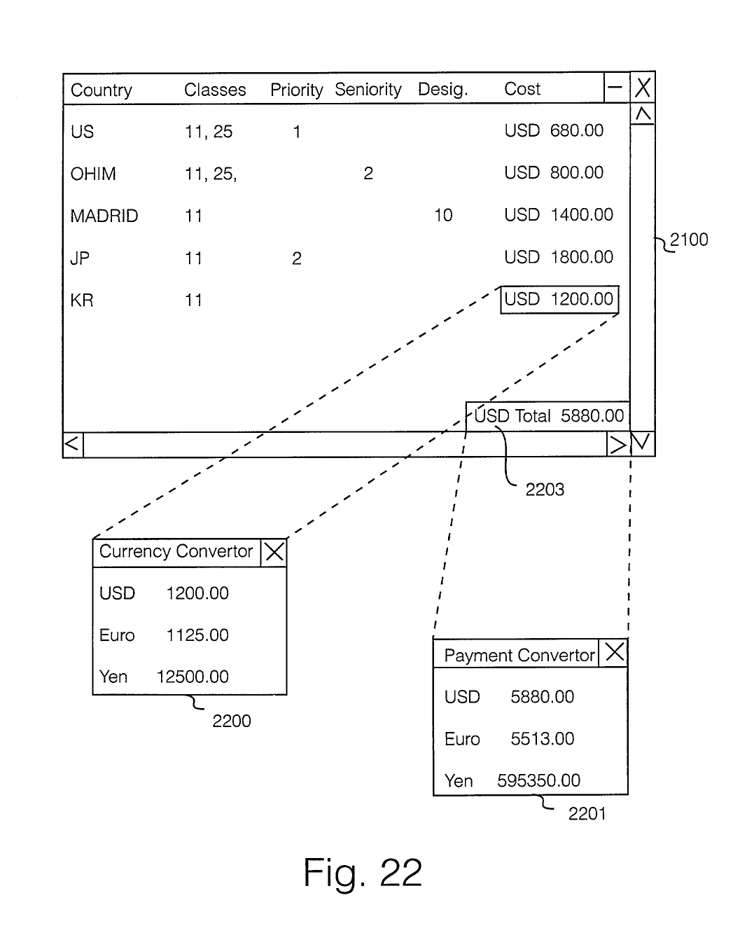

Referring to FIG. 22 herein, there is illustrated schematically a currency converter expansion window 2200 and a payment converter expansion window 2201. The currency converter expansion window 2200 is activated by double-clicking a pointer device, having an icon presented over a cost data in the fifth column of the expanded cost calculator window 2100. The currency converter expansion window shows equivalent amounts of a cost in other currencies. For example, where the key currency is USD, the currency converter may show vendors price in Euro or Yen for comparison. The currency converter window may be activated on any country total, or on any official fee or vendor fee or associate fee, where these appear on the breakdown expansion window 2101.

The payment converter window 2201 is activated by double-clicking a pointing device, with an icon present over the total filing program cost 2203 shown in the cost calculator expansion window 2100. The payment converter window allows a customer to select a different currency of payment, by highlighting the preferred currency and closing the payment converter window. This results in all costs being displayed in the customer selected currency instead of the key currency. This enables a customer to compare costs in a currency in which the customer is more familiar with.

1. A method of determining a cost data relating to a cost of a registered trade mark application, said method characterized by comprising the steps of:
receiving input data describing a trade mark;
receiving input data describing at least one territory;
receiving input data describing a number of classes of goods/services for a said registered trade mark application;
storing component cost data relating to a plurality of component costs of said registered trade mark application in at least one territory; and
calculating substantially in real time said cost data relating to a cost of said registered trade mark application from said stored data.

2. The method as claimed in claim 1, wherein a said calculated cost data is generated by:
reading said stored cost data from a look up table comprising a plurality of individual component costs for each of a plurality of individual territories; and
adding a plurality of said individual component costs to obtain said calculated cost data.

3. The method as claimed in claim 1, further comprising the step of:
displaying said calculated cost substantially in real time.

4. The method as claimed in claim 1, further comprising the step of:
calculating said calculated data cost in a plurality of different currencies.

5. The method as claimed in claim 1, wherein said step of calculating comprises calculating a said calculated cost in a first currency, and converting said calculated cost to a second currency.

6. The method as claimed in claim 1, further comprising the step of:
making said calculated cost data available for substantially real time display.

7. The method as claimed in claim 1, wherein said step of storing data comprises, for each of a plurality of territories:
storing at least one official fee cost data relating to an official fee payable to a governmental/intergovernmental body; and
storing at least one vendor fee cost data relating to a vendor fee charged by a vendor of trade mark services.

8. The method as claimed in claim 1, wherein said step of calculating a cost substantially in real time comprises the steps of:
reading from a look up table, a vendor filing cost;
reading from said look up table an official fee for filing said trade mark; and
adding said vendor filing fee cost and said official filing fee cost.

9. The method as claimed in claim 1, wherein said step of receiving data describing a trade mark comprises inputting a bitmap representing a two dimensional image of said trade mark.

10. The method as claimed in claim 1, wherein said step of storing data relating to cost of said registered trade mark application in said country comprises:
for each of a plurality of territories, storing data describing;
a plurality of official fee component costs, describing individual official fees for various operations;
a plurality of vendor fee component costs, each describing a vendor fee levied for a specific service;
a plurality of associate fee component costs, each describing a cost for a service for a specified item levied by an associate.

11. The method as claimed in claim 8, further comprising:
reading from said look up table a vendor priority cost data for claiming a priority; and
adding said vendor priority cost data to said vendor filing cost and said official filing fee cost.

12. The method as claimed in claim 8, further comprising:
reading from said look up table a vendor seniority cost for claiming a seniority; and
adding said vendor seniority cost to said vendor filing cost and said official filing fee cost.

13. The method as claimed in claim 8, further comprising the step of:
reading from said look up table a vendor designation cost for designation of a territory; and
adding said vendor designation cost to said vendor filing fee cost and said official filing fee cost.

14. A method of determining a cost of a registered trade mark application via an online interactive trading system, said method comprising the steps of:
inputting a trade mark;
inputting a specification of goods/services relating to said trade mark;
inputting at least one territory for said trade mark, said method characterized by;
displaying a substantially real time calculated cost of applying for said trade mark in said at least one territory, for said specification of goods/services.

15. The method as claimed in claim 14, wherein said step of displaying comprises making said real time calculated cost available for display via a web server apparatus.

16. The method as claimed in claim 14, further comprising the steps of:
modifying a specification of goods/services by selecting/deselecting classes of goods/services;
wherein said displayed cost is recalculated substantially in real time to reflect a modified cost of said trade mark for said modified specification of goods/services.

17. The method as claimed in claim 14, wherein:
said step of inputting a specification of goods/services comprises inputting a plurality of goods/services categorised in more than one class of a classification system; and
said specification of goods/services is selected from a display comprising a plurality of class icons, each representing an individual class of goods/services.

18. The method as claimed in claim 14, wherein:
said step of inputting a specification of goods/services comprises inputting a plurality of goods/services categorized in at least one class of a classification system; and
modifying said input specification of goods/services so that said modified goods/services are categorized in a different number of classes of said categorization system;
wherein, said cost of said registered trade mark application is calculated substantially in real time to account for modifications to said specification of goods/services.

19. The method as claimed in claim 14, wherein:
said step of inputting at least one territory for said trade mark comprises selecting a plurality of territories from a menu display listing said plurality of territories, said method further comprising the steps of:
modifying a selection of said territories by selecting/deselecting individual territory icons on a screen display, to obtain a modified selection of territories;
wherein said displayed cost is recalculated substantially in real time to reflect a modified cost of said trade mark for said modified selection of territories.

20. The method as claimed in claim 14, further comprising the steps of:
inputting at least one priority claim;
wherein said displayed cost is recalculated substantially in real time to reflect a modified cost of said trade mark including said at least one priority claim.

21. The method as claimed in claim 14, further comprising the step of:
inputting a selection of at least one priority claim for claiming a priority right from at least one earlier trade mark; and
modifying said selection of said at least one priority claim by selecting/deselecting at least one said priority claim to obtain a modified priority claim selection;
wherein said displayed cost is recalculated substantially in real time to represent a modified cost of said trade mark for said modified selection.

22. The method as claimed in claim 14, further comprising the steps of:
inputting at least one seniority claim for claiming seniority from at least one earlier trade mark;
wherein said displayed cost is recalculated substantially in real time according to said input of at least one seniority claim.

23. The method as claimed in claim 14, further comprising the step of:
inputting a selection of at least one seniority claim, for claiming a seniority right from at least one earlier trade mark; and
modifying said selection of at least one seniority claim by selecting/deselecting a said at least one seniority claim to obtain a modified seniority claim selection;
wherein said displayed cost is recalculated substantially in real time to represent a modified cost of said trade mark for said modified selection.

24. The method as claimed in claim 14, further comprising the step of:
inputting at least one designated territory for a regional trade mark;
wherein said displayed cost is recalculated in real time according to said input of said at least one designated territory.

25. The method as claimed in claim 14, further comprising:
displaying a set of component costs used for calculating said substantially real time calculated costs; and
selecting/deselecting individual said component costs to modify said real time calculated cost of said trade mark.

26. The method as claimed in claim 14, further comprising the step of:
selecting a currency of a plurality of different currencies, in which said cost is displayed.

27. The method as claimed in claim 25, wherein said component costs comprise costs selected from the set:
official fees payable to governmental/intergovernmental bodies; and
vendor fees levied by a vendor providing a trade mark service.

28. The method as claimed in claim 25, further comprising:
displaying a said component cost in a currency selected from a plurality of different currencies.

29. A method of activating a registered trade mark application via an online interactive trade system, said method comprising the steps of:
receiving an input trade mark data describing a trade mark;
receiving an input specification of goods/services relating to the trade mark;
receiving an input selection of at least one territory for said trade mark; characterized by
displaying a substantially real time calculated cost of said trade mark in said at least one territory for said specification of goods/services.

30. A user interface display configured for displaying for a trade mark:
a plurality of classes of goods/services relating to said trade mark;
at least one territory relating to said trade mark; and
a substantially real time calculated cost relating to said trade mark.

31. The user interface as claimed in claim 30, configured for displaying a number of priority claims relating to said trade mark.

32. The user interface as claimed in claim 30, configured for displaying a number of seniority claims relating to said trade mark.

33. The user interface as claimed in claim 30, configured for displaying a number of designated territories relating to said trade mark.

34. The user interface as claimed in claim 30, configured for displaying a number of classes of goods/services relating to said trade marks.

35. The user interface as claimed in claim 30, configured to display for a trade mark:
a plurality of territories, and for each said territory;
a number of selected classes of goods/services;
a number of priority claims; and
a cost of applying for said trade mark in said territory.

36. A method of online trading, for instructing a registered trade mark application, said method comprising:
generating a display window for a trade mark, said display window displaying:
a list of individual territories relating to said trade mark;
for each said territory, a list of classes of goods/services of said trade mark in said territory;
for each said territory, a cost of said trade mark;
wherein said cost is calculated substantially in real time.

37. The method as claimed in claim 36, wherein said display window is also configured for displaying;
whether a priority claim is made for said mark in a said territory;
whether a seniority claim is made for said mark in a said territory;
wherein, any of said priority claim, said seniority claim, or any said class of goods/services may be interactively selected/deselected, and wherein
said cost is recalculated substantially in real time to reflect a modified cost of said mark in said territory having a different set of priority, seniority, and classes of goods/services.

38. A user interface for an online trading system, for filing a registered trade mark application, said user interface comprising:
a cost calculator window, displaying at least one trade mark in at least one country, and a calculated cost relating to said trade mark;
a currency conversion window activated as an expansion of said cost calculator window, said currency conversion window capable of converting a cost from a first currency to a second currency, said cost selected from:
a total filing cost of a trade mark application in an individual territory;
a total cost of a filing program of a trade mark in a plurality of territories;
an official fee; a vendor fee charged by a vendor for providing a trade mark service; an associate fee charged by an associate for performing a trade mark service.

39. Means for generating a user interface display for displaying data relating to a trade mark, said data comprising:
data describing said trade mark;
data describing at least one territory relating to said trade mark;
data describing at least one class of goods/services relating to said trade mark;
data relating to a cost of said trade mark;
said means comprising:
means for storing of component cost data for a trade mark in each of a plurality of territories;
means for calculating substantially in real time, a cost of said trade mark in at least one said territory.

40. Means as claimed in claim 39, further comprising a web server allowing said display to be viewed from a plurality of remote locations.

41. Means as claimed in claim 39, wherein said means for calculating substantially in real time a cost of said trade mark, calculates said cost from an input data received from a customer terminal, and said stored component cost data.
